(19) United States
(12) Patent Application Publication
(10) Pub. No.: US 2017/0177126 A1
(43) Pub. Date: Jun. 22, 2017

(54) METAL MESH SENSING MODULE OF TOUCH PANEL AND MANUFACTURING METHOD THEREOF

(71) Applicant: JTOUCH Corporation, Taoyuan City (TW)

(72) Inventors: Yu-Chou Yeh, Taoyuan City (TW); Ting-Ching Lin, Taoyuan City (TW); Yi-Chin Chen, Taoyaun City (TW); Jia-Hao Kang, Taoyuan City (TW)

(21) Appl. No.: 15/068,091

(22) Filed: Mar. 11, 2016

(30) Foreign Application Priority Data
Dec. 18, 2015 (TW) 104142697

(51) Int. Cl. G06F 3/041; G06F 3/047

(52) U.S. Cl. CPC G06F 3/0412; G06F 3/047; G06F 2203/04103

(57) ABSTRACT

A metal mesh sensing module of a touch panel and a manufacturing method thereof are disclosed. The metal mesh sensing module includes a transparent substrate and a metal mesh sensing circuit. The transparent substrate has at least a surface and plural referring nodes disposed on the surface and arranged in regular order. The metal mesh sensing circuit is disposed on the surface and has plural mesh nodes, plural turning points and plural metallic lines. Each mesh node is defined relative to the corresponding referring node and disposed on the surface. Each turning point is randomly selected from a shiftable zone having the center aligned to a point located between two adjacent referring nodes. Each mesh node is connected to the adjacent turning points on the surface, so as to form the metal mesh sensing circuit configured as a visible touch zone.

### FIELD OF THE INVENTION

The present invention relates to a metal mesh sensing module of a touch panel and a manufacturing method thereof, and more particularly to a metal mesh sensing module of a touch panel for reducing Moire effect and a manufacturing method thereof.

### BACKGROUND OF THE INVENTION

Nowadays, touch control technologies are widely applied to the touch display devices of various electronic products in order to facilitate the users to control the operations of the electronic products. Moreover, for achieving the displaying function and making the sensing electrodes of the visible touch zone unrecognizable, transparent sensing electrodes are usually used as the electrodes of the touch zone of the display panel. For example, the transparent sensing electrodes are made of indium tin oxide (ITO). As the trend of designed touch panel is developed toward the large-sized touch panel, the uses of the ITO transparent electrodes have some drawbacks. For example, the resistance value is increased and the sensing response speed is reduced. In addition, since the method of fabricating the large-sized touch panel with the ITO transparent electrodes needs many steps, the fabricating cost is increased. Consequently, a metal mesh sensing electrode is gradually employed to replace the ITO transparent electrode.

However, when the metal mesh sensing module of the touch panel is attached on a display module, a Moire effect is readily generated. The displaying quality is adversely affected by the Moire effect. As known, the profiles of the mesh pattern of the metal mesh sensing module may influence the generation of Moire. Generally, if the adjacent mesh patterns are regularly arranged, the possibility of generating the Moire effect increases. Moreover, if the wire width of the mesh pattern increases or the adjacent patterns overlap or crisscross with each other, the possibility of generating the Moire effect also increases. Moreover, if the metal mesh sensing module of the touch panel and the thin film transistor array (e.g. the black matrix or the RGB pixel array) of the display module both are regular mesh structures, the possibility of generating the Moire effect would also increase when the touch panel is attached on the display module and these two regular mesh structures are overlapped with each other.

For avoiding or minimizing the Moire phenomenon, the mesh pattern profiles of the metal mesh sensing module of the touch panel may be designed according to the thin film transistor array of the display module. In particular, for increasing the visibility, plural linear metal lines are regularly arranged in a crisscrossed form so as to define the mesh pattern profile of the metal mesh sensing module. For example, the mesh pattern comprises plural linear first metal lines and plural linear second metal lines. The plural linear first metal lines are oriented along a first direction and in parallel with each other. The plural linear second metal lines are oriented along a second direction and in parallel with each other. Moreover, the plural linear first metal lines and the plural linear second metal lines are crisscrossed and isolated with each other. Consequently, a touch-sensitive array pattern is defined by the plural linear first metal lines and the plural linear second metal lines collaboratively. As mentioned above, the mesh pattern of the metal mesh sensing module of the touch panel should be arranged to match the thin film transistor array of the display module for reducing the Morie phenomenon. Under this circumstance, the spacing intervals between the plural metal lines and the crisscrossing angles of the metal lines should be elaborately designed. In other words, the designing complexity increases. The visibility is readily reduced because of the error designing of the mesh pattern of the metal mesh sensing module. On the other hand, if the mesh pattern is designed by random patterns for solving the problem of interference, the designed mesh pattern will have the mesh opening with abnormal aperture ratio and unequal distribution, and cause the phenomenon of uneven light intensity. When several random-designed patterns are combined with each other, it is not easy to splice them together or the interference will be introduced, because each interface among spliced patterns has nodes selected randomly.

Therefore, there is a need of providing an improved metal mesh sensing module of a touch panel and a manufacturing method thereof in order to overcome the above drawbacks.

### SUMMARY OF THE INVENTION

The present invention provides a metal mesh sensing module of a touch panel and a manufacturing method thereof. By randomly designing the mesh pattern of the metal mesh sensing module, the possibility of generating the interference caused by the overlapping or cross points of patterns is avoided.

The present invention further provides a metal mesh sensing module of touch panel and a manufacturing method thereof. The possibility of generating the mesh opening with abnormal aperture ratio and unequal distribution in random-designed mesh patterns will be avoided by controlling the random designed mesh pattern of the metal mesh sensing module precisely in a specific condition. Consequently, the phenomenon of uneven light intensity will be avoided while the metal mesh sensing module is applied to a touch display apparatus.

The present invention further provides a metal mesh sensing module of a touch panel and a manufacturing method thereof. Since the random designed patterns of the metal mesh sensing module can be controlled precisely by using specific shiftable zone, there won't be abnormal opening and spliced mark generated in the spliced interface of the mesh patterns while more than two random-designed mesh patterns are spliced together. The interference caused by the interface between two spliced patterns is avoided and the visibility is not influenced.

The present invention further provides a touch panel of sensing electrode and a manufacturing method thereof. The mesh patterns can be designed according to the arrangement of pixel units in a display panel for reducing the Moire effect and enhancing the visibility.

In accordance with an aspect of the present invention, there is provided a metal mesh sensing module. The metal mesh sensing module includes a transparent substrate and a metal mesh sensing circuit. The transparent substrate has at least a surface and plural referring nodes disposed on the surface and arranged in regular order. The metal mesh sensing circuit is disposed on the surface and having plural mesh nodes, plural turning points and plural metallic lines. Each mesh node is defined relative to the corresponding referring node and disposed on the surface. Each turning point is randomly selected from a shiftable zone having the center aligned to a referring point located between two adjacent referring nodes. Each mesh node is connected to the adjacent turning points on the surface, so as to form the metal mesh sensing circuit configured as a visible touch zone.

In accordance with an aspect of the present invention, there is provided a manufacturing method of a metal mesh sensing module. The manufacturing method includes the following steps. A transparent substrate is provided and the transparent substrate has at least a surface. Plural referring nodes are defined and disposed on the surface of the transparent substrate and arranged in regular order. Then, a shfitable zone is defined. Plural turning points are obtained relative to the referring nodes, wherein each turning point is randomly selected from the shiftable zone having the center aligned to a point located between the corresponding two adjacent referring nodes. Plural mesh nodes are defined relative to the plural referring nodes, and then the metal mesh sensing circuit having plural metal lines connecting each mesh node with the adjacent turning points on the surface is formed and configured as a visible touch zone.

The above contents of the present invention will become more readily apparent to those ordinarily skilled in the art after reviewing the following detailed description and accompanying drawings, in which:

### BRIEF DESCRIPTION OF THE DRAWINGS

FIG. 1 shows a flow chart of manufacturing a metal mesh sensing module of a touch panel according to the first embodiment of the present invention;

FIGS. 2A to 2D schematically illustrate the structure of the metal mesh sensing module of the touch panel at different steps of FIG. 1;

FIG. 3 shows a flow chart of manufacturing a metal mesh sensing module of a touch panel according to the second embodiment of the present invention;

FIGS. 4A to 4C schematically illustrate the structure of the metal mesh sensing module of the touch panel at different steps of FIG. 3;

FIG. 5 illustrates an exemplary metal mesh sensing circuit having plural spliced mesh patterns;

FIG. 6 schematically illustrates a partial enlargement of P zone in FIG. 5 according to different embodiment;

FIG. 7 shows a flow chart of manufacturing a metal mesh sensing module of a touch panel according to the third embodiment of the present invention;

FIGS. 8A to 8C schematically illustrate the structure of the metal mesh sensing module of the touch panel at different steps of FIG. 7; and

FIG. 9 schematically illustrates the relative arrangement of the metal mesh sensing module of FIG. 1 and the pixel units of a display module according to a preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

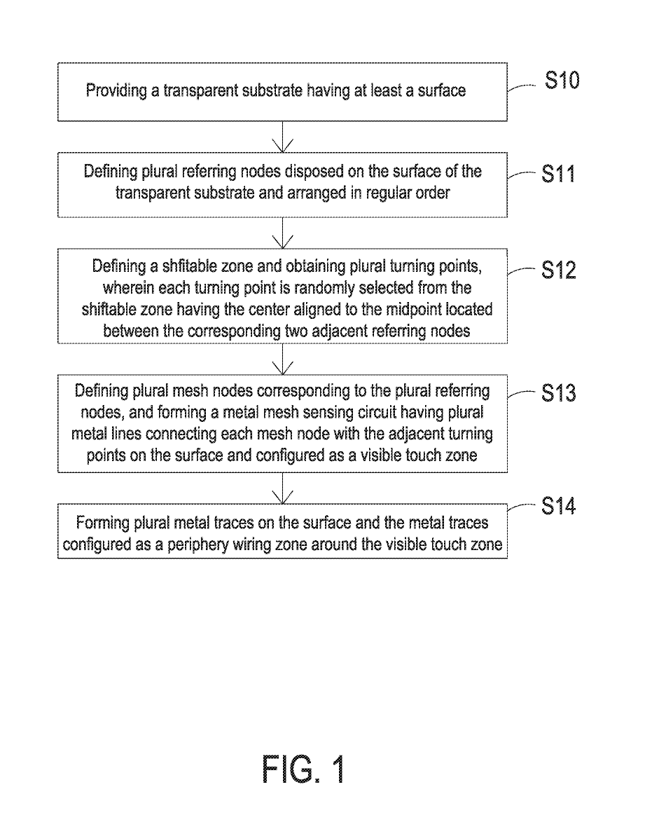

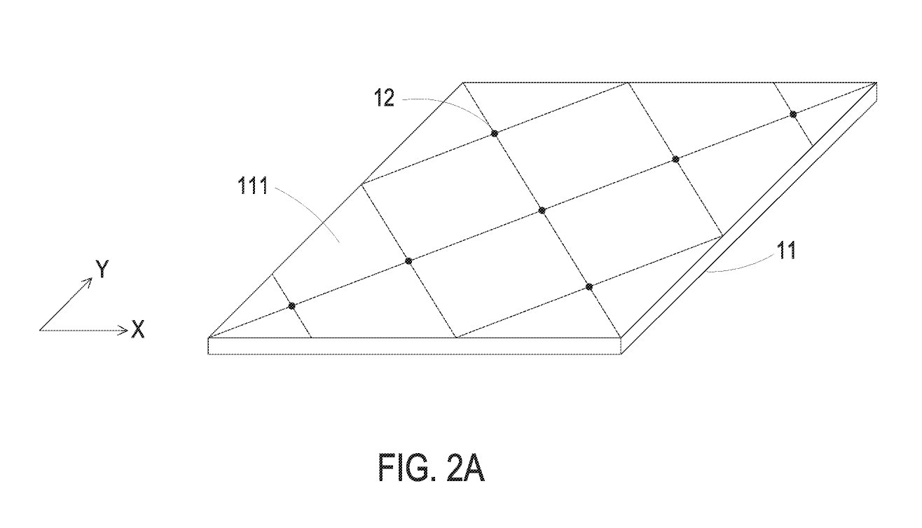

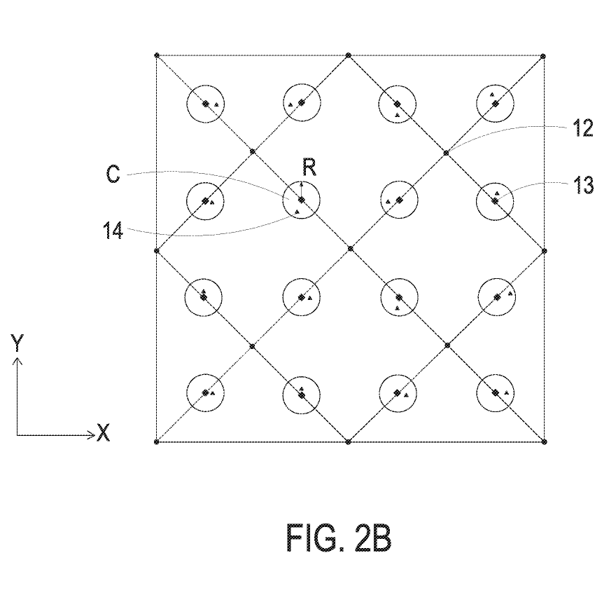

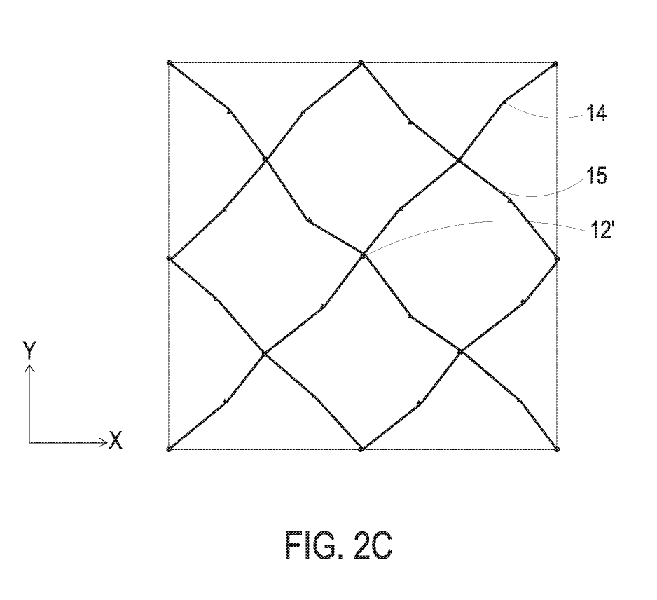

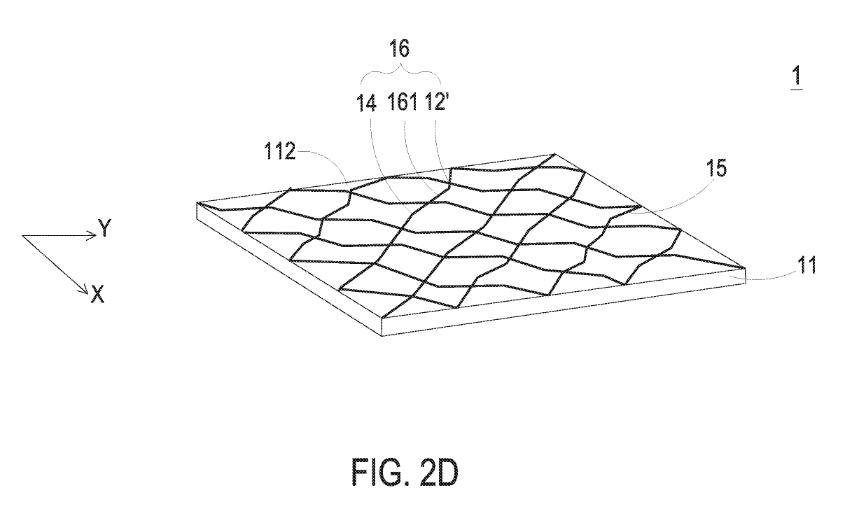

FIG. 1 shows a flow chart of manufacturing a metal mesh sensing module of a touch panel according to the first embodiment of the present invention. FIGS. 2A to 2D schematically illustrate the structure of the metal mesh sensing module of the touch panel at different steps of FIG. 1. As shown in FIGS. 1 and 2A, a transparent substrate 11 is provided (as shown in the step S10). The transparent substrate 11 has a surface 111. Plural referring nodes 12 are defined on the surface 111 (as shown in the step S11). In this step, the plural referring nodes 12 are arranged as diamond arrays extending along but not limited to X-Y axis. In some embodiments, any extendable array, for example but not limited to triangular arrays, square arrays, rectangle arrays, hexagonal arrays or octagonal arrays, is suitable to be implemented. Then, as shown in FIGS. 1 and 2B, each midpoint between any two adjacent referring nodes 12 is defined as a referring point 13 and a shiftable zone C is defined for obtaining plural turning point 14. Each turning point 14 is randomly selected from the shiftable zone C having the center aligned to the corresponding referring point 13 (as shown in the step S12). In the embodiment, the shiftable zone C is a circle area defined by a predetermined radii R. The predetermined radii R is defined according to the line spacing, i.e. the distance between any two adjacent referring nodes 12. A specific ratio of the predetermined radii R to the distance between any two adjacent referring nodes or any two adjacent second referring nodes is ranged from 0.5% to 12.5%, and more perfectly ranged from 1% to 10%. Namely, the predetermined radii R is ranged from 3 um to 50 um, and more perfectly ranged from 5 um to 30 um. Then, as shown in FIGS. 1 and 2C, plural referring nodes 12 are defined as plural mesh nodes 12′ and each mesh node 12′ is connected to the adjacent turning points 14 on the surface 111 and the metal mesh sensing circuit 15 is formed on the surface 111 (as shown in the step S13). In this step, the profile of the metal mesh sensing circuit 15 is transferred and formed on the surface 111 of the transparent substrate 11 by a photolithography process and etching process and a metal mesh sensing electrode 16 is formed and configured as a visible touch zone 112, as shown in FIG. 2D.

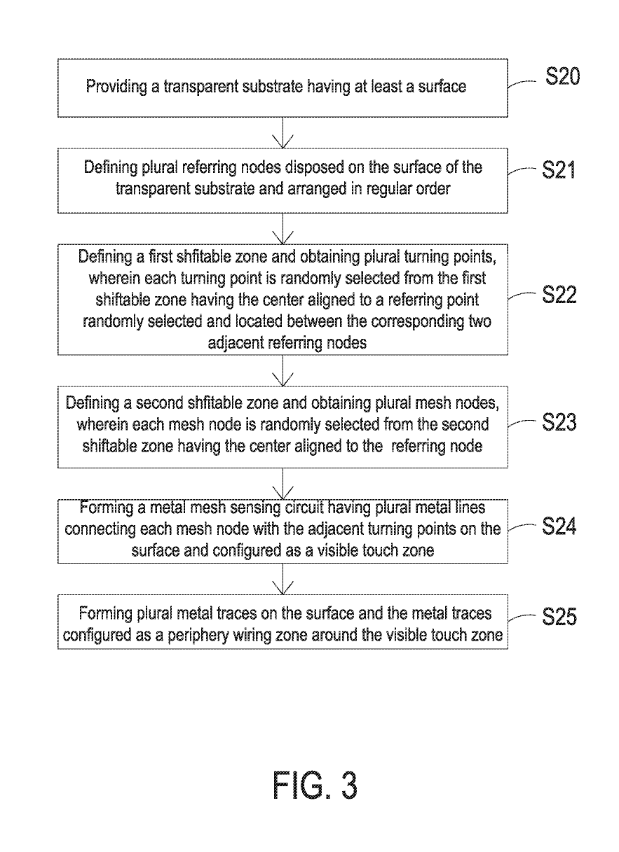

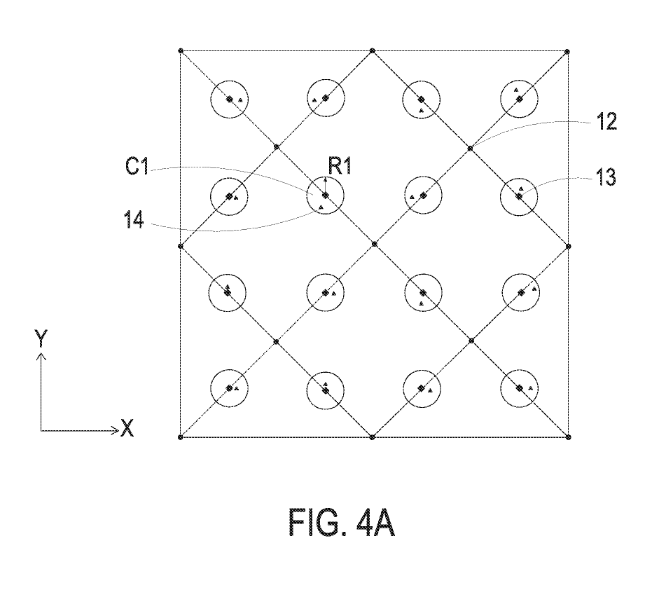

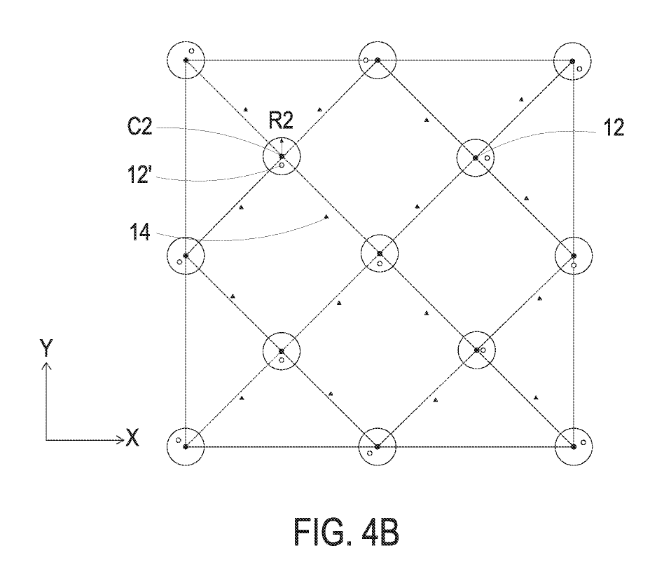

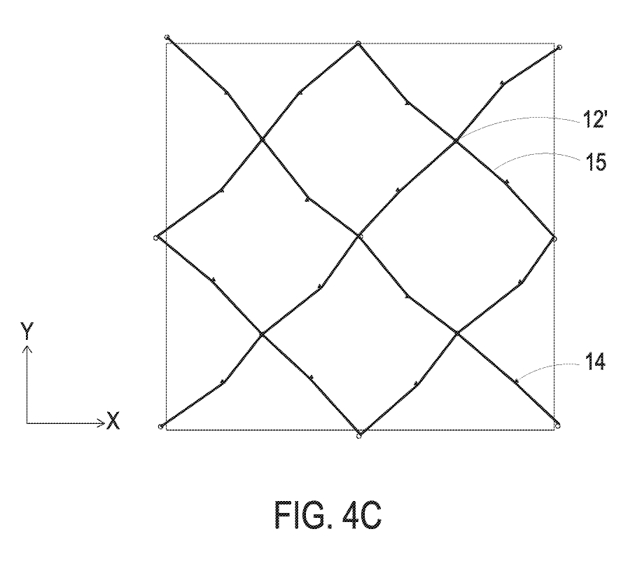

FIG. 3 shows a flow chart of manufacturing a metal mesh sensing module of a touch panel according to the second embodiment of the present invention. FIGS. 4A to 4C schematically illustrate the structure of the metal mesh sensing module of the touch panel at different steps of FIG. 3. As shown in FIG. 2A and 3, a transparent substrate 11 is provided (as shown in the step S20). The transparent substrate 11 has a surface 111. Plural referring nodes 12 are defined on the surface 111 (as shown in the step S21). In this step, the plural referring nodes 12 are arranged as diamond arrays extending along but not limited to X-Y axis. In some embodiments, any extendable array, for example but not limited to triangular arrays, square arrays, rectangle arrays, hexagonal arrays or octagonal arrays, is suitable to be implemented. Then, as shown in FIGS. 3 and 4A, plural referring points 13 are defined relative to plural referring nodes 12. Each referring point 13 is randomly selected between and corresponding to two adjacent referring nodes 12. A first shiftable zone C1 is defined for obtaining plural turning point 14. Each turning point 14 is randomly selected from the first shiftable zone C1 having the center aligned to the corresponding referring point 13 (as shown in the step S22). As shown in FIGS. 3, 4A and 4B, a second shiftable zone C2 is defined and plural mesh nodes 12′ are obtained relative to the plural referring nodes 12. Each mesh node 12′ is randomly selected from the second shiftable zone C2 having the center aligned to the corresponding referring node 12 (as shown in the step S23). In the embodiment, the first shiftable zone C1 and the second shiftable zone C2 are circle areas defined by a first predetermined radii R1 and a second predetermined radii R2, respectively. The first predetermined radii R1 and the second predetermined radii R2 are defined according to the line spacing, i.e. the distance between any two adjacent referring nodes 12. A specific ratio of the first predetermined radii R1 or the second predetermined radii R2 to the distance between any two adjacent referring nodes 12 is ranged from 0.5% to 12.5%, and more perfectly ranged from 1% to 10%. Namely, the predetermined radii R is ranged from 3 um to 50 um, and more perfectly ranged from 5 um to 30 um. Then, as shown in FIGS. 4C, each mesh node 12′ is connected to the adjacent turning points 14 on the surface 111 and the metal mesh sensing circuit 15 is formed on the surface 111 (as shown in the step S13). In this step, the profile of the metal mesh sensing circuit 15 is transferred and formed on the surface 111 of the transparent substrate 11 by a photolithography process and etching process and a metal mesh sensing electrode 16 is formed and configured as a visible touch zone 112 (Please refer to FIG. 2D).

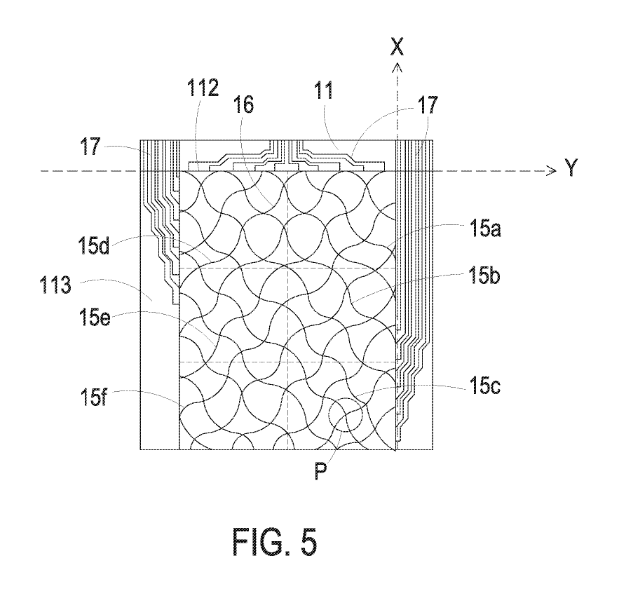

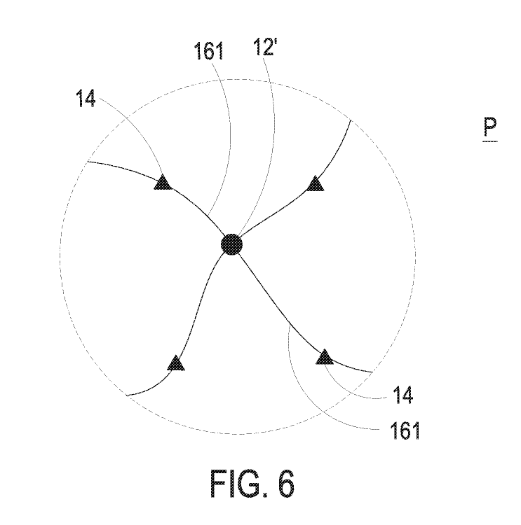

In the above embodiments, the metal mesh sensing circuit 15 is regarded as a mesh pattern having random and unrepeated units. In some embodiments, plural mesh patterns of the metal mesh sensing circuit 15 can be spliced and combined as a larger mesh pattern for forming the metal mesh sensing electrode 16 on the surface 111 of the transparent substrate 11. FIG. 5 illustrates an exemplary metal mesh sensing circuit having plural spliced mesh patterns. In the embodiment, the touch panel 1 includes a transparent substrate 11, a metal mesh sensing electrode 16 and plural metal traces 17. The transparent substrate 11 has at least a surface 111 (Please refer to FIG. 2A). The metal mesh sensing electrode 16 is disposed on the transparent substrate 11 and configured to form a visible touch zone 112. The metal mesh sensing electrode 16 has plural mesh nodes 12′, plural turning points 14 and plural metal lines 161, as shown in FIG. 2D. The plural mesh nodes 12′ are relative to and disposed on the plural referring nodes 12. Each turning point 14, similar to the above embodiments, is randomly selected from the shiftable zone C and the first shiftable zone C1. The metal lines are connected between the mesh nodes 12′ and the adjacent turning points 14 for forming the metal mesh sensing electrode 16. In the embodiment, the metal mesh sensing electrode 16 is formed by plural spliced mesh patterns of the metal mesh sensing circuit 15a to 15f. Two adjacent mesh patterns are spliced together by overlapping the mesh nodes 12′ located at the spliced interface. Plural mesh patterns of the metal mesh sensing circuit 15a to 15f are spliced together along a first direction (such as X axis) or a second direction (such as Y axis) to obtain the larger combined metal mesh sensing pattern. In the embodiment, the metal mesh sensing electrode 16 is formed by but not limited to 6 (i.e. 2×3=6) mesh patterns of the metal mesh sensing circuit 15a to 15f. In addition, the touch panel 1 has the plural metal traces 17 disposed on the transparent substrate 11 and configured to form a periphery wiring zone 113 around the visible touch zone 112. The plural metal traces 17 are formed by but not limited to a photolithography process and etching process, similar to the step S14 of FIG. 1 and the step S24 of FIG. 3. In the embodiment, the metal mesh sensing circuit 15 has plural mesh nodes 12′ arranged in regular order. When one mesh pattern of the metal mesh sensing circuit 15 is spliced with another one, the mesh nodes 12′ located at the spliced interface thereof and arranged in regular order can be easily jointed with each other. Consequently, the difficulties of splicing or the abnormal opening caused by the conventional excessive-random and shifted nodes or the spliced mark caused while mesh patterns are designed to splice together can be avoided. In some embodiment, the metal mesh sensing electrode 16 and the metal traces 17 are transferred and formed on the transparent substrate 11 by a photolithography process and etching process. In the embodiment, the metal line 161 connected the adjacent mesh node 12′ with the adjacent turning point 14 is but not limited to a straight line. In some embodiment, the metal line 161 connected the mesh node 12′ with the adjacent turning point 14 includes at least portion of curved line. FIG. 6 illustrates a partial enlargement of P zone in FIG. 5 according to another different embodiment. As shown in FIGS. 5 and 6, in the embodiment, the metal line 161 connected between the adjacent mesh node 12′ and the adjacent turning point 14 is a spline line obtained by a spline interpolation. Each spline line connects the relative mesh nodes 12′ and the relative turning points 14, wherein the referring nodes 12 corresponding to the relative mesh nodes 12′ and the referring points 13 corresponding to the relative turning points 14 are located at a straight line. Namely, the relative mesh nodes 12′ and the relative turning points 14 respectively defined by the corresponding referring nodes 12 and the corresponding referring points 13 located at a straight line are regarded as a group. The group has the relative mesh nodes 12′ and the relative turning points 14 as fixing points to simulate and obtain the spline line. Alternatively, the plural metal lines 161 connected any mesh node 12 with the adjacent turning point 14 can be randomly grouped to simulate and obtain a spline line, but not limited to an opened or a closed spline line.

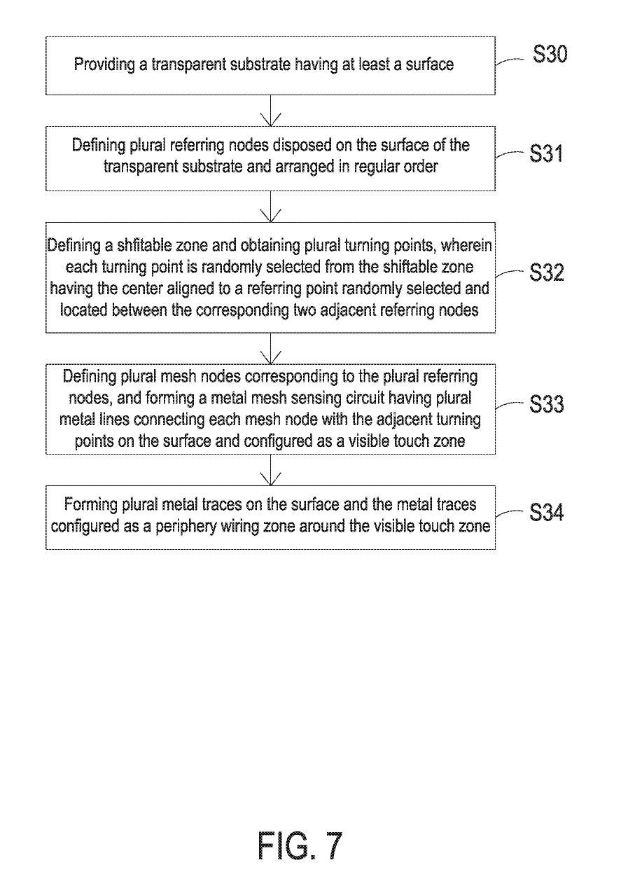

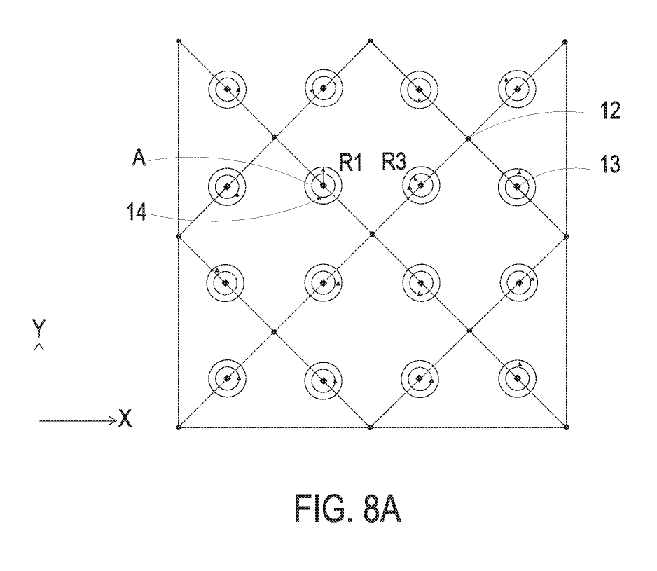

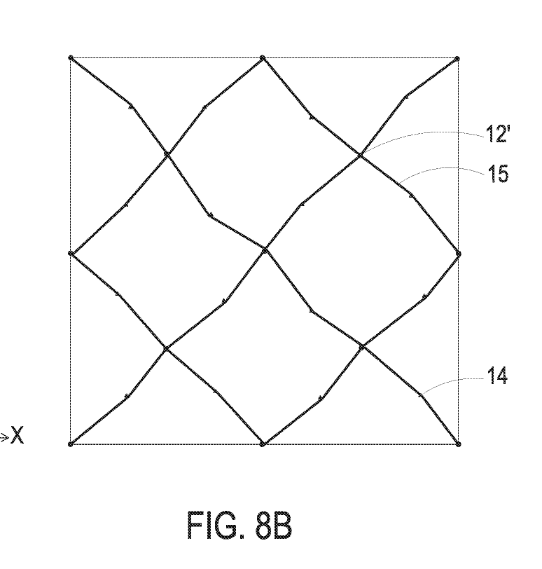

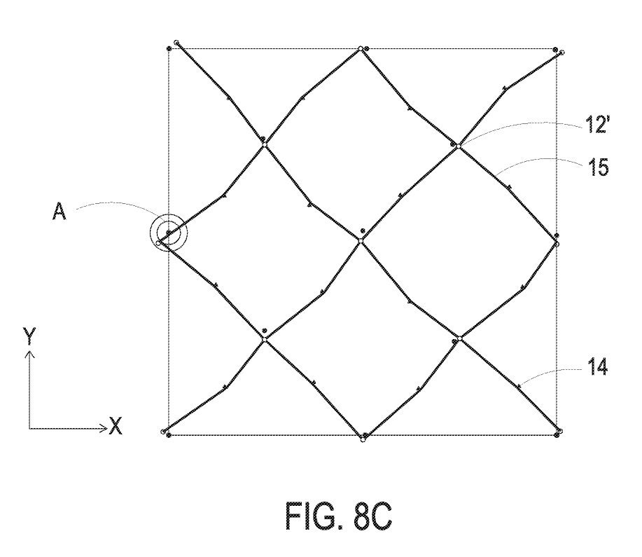

FIG. 7 shows a flow chart of manufacturing a metal mesh sensing module of a touch panel according to the third embodiment of the present invention. FIGS. 8A to 8B schematically illustrate the structure of the metal mesh sensing module of the touch panel at different steps of FIG. 7. As shown in FIG. 2A and 7, a transparent substrate 11 is provided (as shown in the step S30). The transparent substrate 11 has a surface 111. Plural referring nodes 12 are defined on the surface 111 (as shown in the step S31). In this step, the plural referring nodes 12 are arranged as diamond arrays extending along but not limited to X-Y axis. In some embodiments, any extendable array, for example but not limited to triangular arrays, square arrays, rectangle arrays, hexagonal arrays or octagonal arrays, is suitable to be implemented. Then, plural referring points 13 are defined relative to plural referring nodes 12. Each referring point 13 is randomly selected between and corresponding to two adjacent referring nodes 12. A shiftable zone A is defined for obtaining plural turning point 14. Each turning point 14 is randomly selected from the first shiftable zone A having the center aligned to the corresponding referring point 13 (as shown in the step S32). In the embodiment, the shiftable zone A is but not limited to a ring area or two circumferences defined by a first predetermined radii R1 and a third predetermined radii R3. The first predetermined radii R1 is larger than the third predetermined radii R3. A specific ratio of the first predetermined radii R1 or the third predetermined radii R3 to the distance between any two adjacent referring nodes is ranged from 0.5% to 12.5%, and more perfectly ranged from 1% to 10%. Namely, the first predetermined radii R1 and the third predetermined radii R3 are ranged from 3 um to 50 um, and more perfectly ranged from 5 um to 30 um. Then, as shown in FIGS. 7 and 8B, each mesh node 12′ defined by the corresponding referring node 12 is connected to the adjacent turning points 14 on the surface 111 and the metal mesh sensing circuit 15 is formed on the surface 111 (as shown in the step S33). In this step, the profile of the metal mesh sensing circuit 15 is transferred and formed on the surface 111 of the transparent substrate 11 by a photolithography process and etching process and a metal mesh sensing electrode 16 is formed and configured as a visible touch zone 112 (Please refer to FIG. 2D). Alternatively, each mesh node 12′ is randomly selected from the shiftable zone A and connected to the adjacent turning points 14 on the surface 111, so as to form the metal mesh sensing circuit 15 on the surface 111 of the transparent substrate 11, as shown in FIG. 8C.

In the above embodiments, the metal mesh sensing electrode 16 of the touch panel 1 is formed according to the spliced profile of the metal mesh sensing circuit 15 by photolithography process and etching process, and transferred and formed on the transparent substrate 11 with the metal traces 17 (as shown in FIG. 5). The random pattern of the metal mesh sensing circuit 15 are obtained by the turning points disposed between any two referring nodes, and won't causes uneven openings with abnormal aperture ratio. When the mesh nodes defined as the referring nodes and arranged in regular order, it is easy to splice profiles by jointing the mesh nodes located at the interface between two mesh patterns of the metal mesh sensing circuits, and there is no spliced mark generated in the spliced interface. In some embodiment, as shown in FIG. 3, each mesh node 12′ is randomly selected from the second shiftable zone C2 having the center aligned to the corresponding referring node 12. The second shiftable zone C2 is a circle area defined by the second predetermined radii R2, but not limited to equal to or smaller than the first shiftable zone C1 defined by the first predetermined radii R1. When two mesh patterns of the metal mesh sensing circuits 15 are spliced together, the referring nodes 12 located at the interfaces thereof are facilitated to splice. Namely, the mesh nodes 12′ are disposed and limited in the corresponding second shiftable zone C2, and the size of the second shiftable zone C2 is controllable (i.e. the second shiftable zone C2 can be controlled by determining the second predetermined radii R2.) If the second predetermined radii R2 is very small, the mesh nodes are arranged in regular order, and there won't be the abnormal opening or the spliced mark obtained in the spliced interface of the mesh patterns. In other embodiment, the metal mesh sensing circuit 15 has the regular mesh nodes defined by the referring nodes and located at the boundary thereof. It is easy to spliced profiles by jointing the mesh nodes arranged in regular order. There is no spliced mark obtained in the spliced interface and the visibility is not influenced.

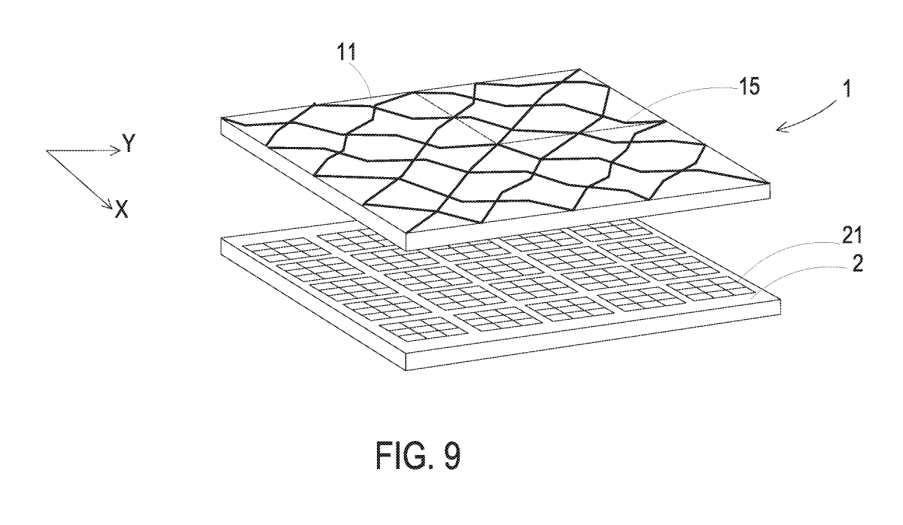

In some embodiments, the referring nodes 12 can be respectively arranged as but not limited to triangular arrays, square arrays, rectangle arrays, hexagonal arrays or octagonal arrays. In this embodiment, they are arranged as the diamond arrays, but the present invention is not limited to this embodiment. FIG. 9 schematically illustrates the relative arrangement of the metal mesh sensing module of FIG. 1 and the pixel units of a display module according to a preferred embodiment of the present invention. As shown in FIG. 9, each mesh pattern of the metal mesh sensing circuit 15 of the metal mesh sensing module 1 is corresponding to the pixel units 21 of the display module 2. The pixel units 21 are consisted of red pixel units, green pixel units and blue pixel units. In some embodiments, a display panel 2 includes the pixel units 21 arranged in different zones. For minimizing the Moire effect and the interference caused by the arrangement of the pixel units, the referring nodes can be defined as different arrays in different zones according to the arrangements and zones of the pixel units of the display panel 2. Each mesh pattern of the metal mesh sensing circuit 15 have the length larger than that of each pixel unit 21.

In summary, the present provides a metal mesh sensing module of a touch panel and manufacturing method thereof. By randomly designing the mesh pattern of the metal mesh sensing module, the possibility of generating the interference caused by the overlapping or cross points of patterns is avoided. In addition, the possibility of generating the mesh opening with abnormal aperture ratio and unequal distribution in random-designed patterns will be avoided by controlling the random designed mesh pattern of the metal mesh sensing module precisely in a specific condition. Consequently, the phenomenon of uneven light intensity will be avoided while the metal mesh sensing module is applied to a touch display apparatus. On the other hand, since the random designed patterns of the metal mesh sensing module can be controlled precisely by using specific shiftable zone, there won't be abnormal opening and spliced mark generated in the spliced interface of the mesh patterns while more than two random-designed mesh patterns are spliced together. Consequently, the interference caused by the interface between two spliced patterns is avoided, and the visibility is not influenced. The mesh patterns can be designed according to the arrangement of pixel units in a display panel for reducing the Moire effect and enhancing the visibility.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A metal mesh sensing module, comprising:
a transparent substrate having at least a surface and plural referring nodes disposed on the surface and arranged in regular order;
a metal mesh sensing circuit disposed on the surface and having plural mesh nodes, plural turning points and plural metallic lines, wherein each mesh node is defined corresponding to the corresponding referring node and disposed on the surface, each turning point is randomly selected from a shiftable zone having the center aligned to a referring point located between two adjacent referring nodes, and each mesh node is connected to the adjacent turning points on the surface, so as to form the metal mesh sensing circuit configured as a visible touch zone.

2. The metal mesh sensing module according to claim 1, wherein each turning point is randomly selected from the shiftable zone having the center aligned to the midpoint located between two adjacent referring nodes.

3. The metal mesh sensing module according to claim 1, wherein the plural mesh nodes are defined on the positions of the plural referring nodes.

4. The metal mesh sensing module according to claim 1, wherein each mesh node is randomly selected from the shiftable zone having the center aligned to the corresponding referring node.

5. The metal mesh sensing module according to claim 1, wherein the shiftable zone is a circumference or a circle area defined by a predetermined radii, and a specific ratio of the predetermined radii to the distance between any two adjacent referring nodes is ranged from 0.5% to 12.5%.

6. The metal mesh sensing module according to claim 5, wherein the predetermined radii and the distance between any two adjacent referring nodes have the specific ratio ranged from 1% to 10%.

7. The metal mesh sensing module according to claim 1, wherein the shiftable zone is two circumferences or a ring area defined by a first predetermined radii and a second predetermined radii, a specific ratio of the first predetermined radii or the second predetermined radii to the distance between any two adjacent referring nodes is ranged from 0.5% to 12.5% and the first predetermined radii is larger than the second predetermined radii.

8. The metal mesh sensing module according to claim 7, wherein the first predetermined radii and the distance between any two adjacent referring nodes have the specific ratio ranged from 1% to 10%.

9. The metal mesh sensing module according to claim 1, further comprising plural metal traces disposed on the surface and configured to form a periphery wiring zone around the visible touch zone.

10. The metal mesh sensing module according to claim 1, wherein the metal line is a straight line or a curved line.

11. The metal mesh sensing module according claim 10, wherein the curved line is a spline line passing through any mesh node and the adjacent turning point.

12. A manufacturing method of metal mesh sensing module, comprising steps of:
(a) providing a transparent substrate having at least a surface;
(b) defining plural referring nodes disposed on the surface of the transparent substrate and arranged in regular order;
(c) defining a shfitable zone and obtaining plural turning points relative to the referring nodes, wherein each turning point is randomly selected from the shiftable zone having the center aligned to a referring point located between the corresponding two adjacent referring nodes; and
(d) defining plural mesh nodes corresponding to the plural referring nodes, and forming a metal mesh sensing circuit having plural metal lines connecting each mesh node with the adjacent turning points on the surface and configured as a visible touch zone.

13. The manufacturing method according to claim 12, wherein the referring point located between the corresponding two referring nodes is the midpoint of the corresponding to two adjacent referring nodes.

14. The manufacturing method according to claim 12, wherein the plural mesh nodes are defined on the positions of the plural referring nodes.

15. The manufacturing method according to claim 12, wherein each mesh node is randomly selected from the shiftable zone having the center aligned to the corresponding referring node.

16. The manufacturing method according to claim 12, wherein the shiftable zone is a circumference or a circle area defined by a predetermined radii, and a specific ration of the predetermined radii to the distance between any two adjacent referring nodes is ranged from 0.5% to 12.5%.

17. The manufacturing method according to claim 16, wherein the predetermined radii and the distance between any two adjacent referring nodes have the specific ratio ranged from 1% to 10%.

18. The manufacturing method according to claim 12, wherein the shiftable zone is two circumferences or a ring area defined by a first predetermined radii and a second predetermined radii, a specific ration of the first predetermined radii or the second predetermined radii to the distance between any two adjacent referring nodes is ranged from 0.5% to 12.5% and the first predetermined radii is larger than the second predetermined radii.

19. The manufacturing method according to claim 12, wherein the metal line is a straight line or a curved line, wherein the curved line is a spline line passing through any mesh node and the adjacent turning point.
